(19) United States
(12) Patent Application Publication
(10) Pub. No.: US 2004/0183215 A1
(43) Pub. Date: Sep. 23, 2004

(54) Electronic device using coating epoxy resin composition

(75) Inventors: Shinetsu Fujieda, Kanagawa-ken (JP); Tetsuo Okuyama, Kanagawa-ken (JP); Hisashi Osanai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/787,113

(22) Filed: Feb. 27, 2004

(30) Foreign Application Priority Data
Feb. 28, 2003 (JP) 2003-052311

(51) Int. Cl. C08L 63/00

(52) U.S. Cl. 257/793

(57) ABSTRACT

The electronic device of the present invention is an electronic device provided with a nonaqueous solvent battery such as a lithium ion secondary battery and with an electronic circuit arranged adjacent to the battery, the adjacent electronic circuit being protected such that it is not adversely affected by an electrolyte leaked from the nonaqueous solvent battery. An epoxy resin composition which is a resin used to protect the circuit is superior in resistance to an electrolyte, water resistance, heat resistance, adhesion, prevention of resin cracks during a cooling and heating cycle and storage stability and is used to protect the electronic circuit, thereby making it possible to improve the life of an electronic device remarkably. The epoxy resin composition used in the present invention is an epoxy resin composition comprising (a) an epoxy resin, (b) a phenol compound and a metal complex as a latent catalyst, (c) a butyral resin and (d) an inorganic filler. It is preferable that this epoxy resin be a liquid at ambient temperature and the latent catalyst be premixed in an epoxy resin in advance.

### CROSSREFERENCE TO RELATED APPLICATION

This application is based upon and claims the benefit of priority from the prior Japanese Patent Application No.2003-52311, filed on Feb. 28, 2003; the entire contents of which are incorporated herein by reference.

### BACKGROUND OF THE INVENTION

1. Field of the Invention

The present invention relates to an electronic device using an epoxy resin composition as an electronic circuit protective material.

2. Description of the Related Art

High voltage and lightweight lithium ion batteries having high energy density are prevalently used as power sources for portable devices and portable electronic devices such as notebook personal computers. As to the performance of batteries, higher capacity, thinner type and lighter-weight batteries are developed every year.

As measures for thinner type and lighter-weight batteries, each company are developing, for example, lithium ion batteries using an aluminum laminate film package in place of conventional metal cell containers. Also, there are increased demands for a guarantee of safety in poor working surroundings every year from the point that these batteries are included within portable devices. For instance, the vapor pressure of a liquid used as an electrolyte is raised in working surroundings where the temperature is made higher. Also, an electrolyte is decomposed to generate gas, which raises the internal pressure in a container and there is therefore a fear that the electrolyte leaks. To deal with this problem, lithium ion batteries are provided with a protective circuit board to suppress the generation of over-current or over discharge from the viewpoint of safety and it is necessary to protect the protective substrate from moisture, a battery electrolyte and other liquids entering from the outside thereby preventing current from leaking on a circuit substrate.

Measures have been taken so far to improve water resistance by coating terminal parts externally exposed with a protective layer of a urethane resin, silicone resin, epoxy resin or the like for protecting electronic devices from external factors (see the publication of Japanese Patent Application Laid-Open No. 8-283409). However, though the coating with a resin composition like this can ensure water resistance, it has no resistance to an electrolyte, such as a non-aqueous solvent electrolyte used in lithium ion batteries, that has strong polarity and can highly dissolve a polymer.

In other words, when an electrolyte leaks in the case of using a coating material which has been usually used so far, the coating layer is deteriorated and peeled off eventually, and further, leak current occurs between wiring on the surface of a substrate and over-current causes a built-in fuse to work, leading to a short circuit, resulting in the occurrence of defective batteries.

### SUMMARY OF THE INVENTION

It is an object of the present invention to realize an electronic device free from an adverse influence on neighboring electronic circuits even if a nonaqueous electrolyte leaks from electronic devices, such as conventional lithium ion batteries, using the electrolyte.

The invention provides an electronic device comprising a battery using a nonaqueous electrolyte and an electronic circuit disposed adjacent to the battery, wherein the electronic circuit is isolated from the battery by an epoxy resin composition containing an epoxy resin, a latent catalyst consisting of a phenol compound and an organic metal compound, a butyral resin and an inorganic filler.

### BRIEF DESCRIPTION OF THE DRAWING

FIG. 1 is a schematic perspective view of a circuit board mounted with a battery and an electronic circuit and shows one example of an electronic device according to the present invention.

### PDESCRIPTION OF THE REFERRED EMBODIMENTS

Embodiments of the present invention will be hereinafter explained in detail.

(Epoxy Resin)

When the epoxy resin composition for coating in the invention is explained in detail, an epoxy resin having at least one epoxy group and preferably two or more epoxy groups in its molecule may be used as the epoxy resin as a first component without any particular limitation in the present invention. Examples of the epoxy resin include compounds having a terminal epoxy such as a glycidyl ether and glycidyl ester, compounds having an internal epoxy and alicyclic epoxy group.

Specific examples of this epoxy resin include, for example, following compounds.

Namely, specific examples of the epoxy resin include bisphenol A type epoxy resins, bisphenol F type epoxy resins, biphenyl type epoxy resins, phenol novolac type epoxy resins, orthocresol novolac type epoxy resins, dicyclopentadiene novolac type epoxy resins, tris-hydroxyphenylmethane type epoxy resins, other polyfunctional type epoxy resins, alicyclic epoxy resins, heterocycle-containing epoxy resins such as triglycidylisocyanate and hydantoin epoxy, hydrogenated bisphenol A type epoxy resins, aliphatic epoxy resins such as propylene glycol diglycidyl ether and pentaerythritol polyglycidyl ether, epoxy resins obtained by a reaction between an aliphatic or aromatic carboxylic acid and epichlorohydrin, spiro ring-containing epoxy resins, glycidyl ether type epoxy resins which are reaction products between an ortho-allyl-phenol novolac compound and epichlorohydrin and glycidyl ether type epoxy resins which are reaction products between a diallylbisphenol compound having an allyl group at the ortho position with respect to each hydroxyl group of bisphenols A and epichlorohydrin.

Also, a brominated epoxy resin for the purpose of imparting flame retardancy may be used. Moreover, the epoxy resin here is preferably an epoxy resin which is in a liquid state at ambient temperature and has a viscosity of 500 poises or less and more preferably 300 poises or less at ambient temperature from the viewpoint of preparing a resin composition which has a low viscosity and is easily handled. Specific examples which may be used as the liquid epoxy resin include Epikote825, Epikote 827, Epikote 828, Epikote 828EL, Epikote 828XA, Epikote 834, Epikote 801, Epikote 801P, Epikote 802, Epikote 802XA, Epikote 815, Epikote 815XA, Epikote 816A, Epikote 819, Epikote 806, Epikote 806L and Epikote 807 (the foregoing products are manufactured by Japan Epoxy Resins Co., Ltd.), CEL-2021P (3,4-epoxycyclohexylmethyl 3′,4′-epoxycyclohexane carboxylate, epoxy equivalent: 128 to 140, viscosity: 200 to 350 cP/25° C.), CEL-2021A (3,4-epoxycyclohexylmethyl 3′,4′-epoxycyclohexane carboxylate, epoxy equivalent: 130 to 145, viscosity: 200 to 450 cP/25° C.), CEL-2000 (1-vinyl-3,4-epoxycyclohexane, 1.5 cP/25° C.) and CEL-3000 (1,2,8,9-diepoxylimonene, epoxy equivalent: 93.5 or less, viscosity: 5 to 20 cP/25° C.) (the foregoing products are manufactured by Daicel Chemical Industries, Ltd.), Denacol EX-421, 201 (resorcin diglycidyl ether), 211 (neopentyl glycol diglycidyl ether), 911 (propylene glycol diglycidyl ether) and 701 (diglycidyl adipate) (the foregoing products are manufactured by Nagase Chemicals Ltd.). These epoxy resins may be used by mixing two or more from the viewpoint of viscosity, heat resistance, adhesiveness and surface hardness.

As other epoxy resins, those which are widely used as (meth) acrylates having an epoxy group may also be used. As to specific examples of these materials, glycidylmethacrylate, 2-methyl-glycidylmethacrylate, epoxidized isoprenyl methacrylate, 3,4-epoxycyclohexanemethanol (meth) acrylate, (meth) acrylate of ε-caprolactam modification of 3,4-epoxycyclohexanemethanol (for example, Cyclomer M100 (epoxy equivalent: 196-213), Cyclomer A200 (epoxy equivalent: 182 to 195) and Cyclomer M101 (epoxy equivalent: 326-355), manufactured by Daicel Chemical Industries, Ltd.) or the like may be polymerized singly or copolymerized with other copolymerizable monomers and used.

Examples of the polymerizable monomer used in the copolymerization include unsaturated fatty acid esters such as alkyl (meth) acrylates, hydroxyl group-containing alkyl (meth) acrylates, alicyclic (meth) acrylates, aromatic acrylates and alicyclic methacrylates containing tertiary carbon in a ring and having 7 to 20 carbon atoms; aromatic vinyl compounds such as styrene, α-methylstyrene, α-ethylstyrene, chlorostyrene, vinyltoluene and t-butylstyrene; vinyl cyanate compounds such as acrylonitrile and methacrylonitrile; and N-substituted maleimides such as N-alkyl group substituted maleimide, N-cycloalkyl substituted maleimide and N-phenylmaleimide.

When a (meth) acrylate or the like having an epoxy group is polymerized singly or with other copolymerizable monomers, an initiator may be used. As the initiator, potassium persulfate, ammonium persulfate, benzoyl peroxide, hydrogen peroxide, di-t-butyl peroxide, dicumyl peroxide, 2,4-dichlorobenzoyl peroxide, decanoyl peroxide, lauryl peroxide, cumene hydroperoxide, t-butyl hydroperoxide, acetyl peroxide, methyl ethyl ketone peroxide, succinic acid peroxide, dicetylperoxydicarbonate, t-butylperoxyacetate, AIBN (2,2′-azobisisobutyronitrile, ABN-N (2,2′-azobis(2-methylbutyronitrile), ABN-V (2,2′-azobis(2,4-dimethylvaleronitrile)), perbutyl O (t-butylperoxy-2-ethylhexanoate) and the like may be used.

The polymerization temperature of the above epoxy resin is 40 to 150° C., preferably 60 to 130° C. and more preferably 100 to 120° C. When the polymerization temperature is higher than the above range, the polymerization is unstable, producing many compounds each having high molecular weight whereas when the polymerization temperature is less than the above range, this takes much time and temperatures out of the above range are therefore undesirable.

As the solvent used in the above polymerization, other epoxy resin (a) may be used. Also, the resin composition may be made by synthesizing a polymer by using a usual solvent having no ionic polymerizing ability, then removing solvents and diluting with the epoxy resin (a). Examples of the solvent having no ionic polymerizing ability include aromatic solvents such as toluene and xylene, methyl ethyl ketone, methyl isobutyl ketone and methoxy propylene glycol acetate. These solvents may be used either singly or by mixing.

In the present invention, as explained above, various types of epoxy resin may be adopted. Epoxy resins constituting an epoxy resin homopolymer containing no polymerizable component except for an epoxy resin have, particularly, excellent solvent resistance and are also superior in mechanical characteristics as a coating agent for electronic devices.

(Latent Catalyst)

In the present invention, a phenol compound and an organic metal compound which have a latent catalytic ability are used by mixing them as a curing catalyst.

In the present invention, examples of the phenol compound used as a first latent catalyst include those represented by the following chemical formula (1).

[Formula 1]

Ar—(OH)ₙ (1)

In the formula (1), Ar represents a substituted or unsubstituted aromatic group or heteroaromatic group and n denotes an integer from 1 to 10.

More specific examples of the compound represented by the chemical formula (1) may include compounds shown below.

[Formula 2]

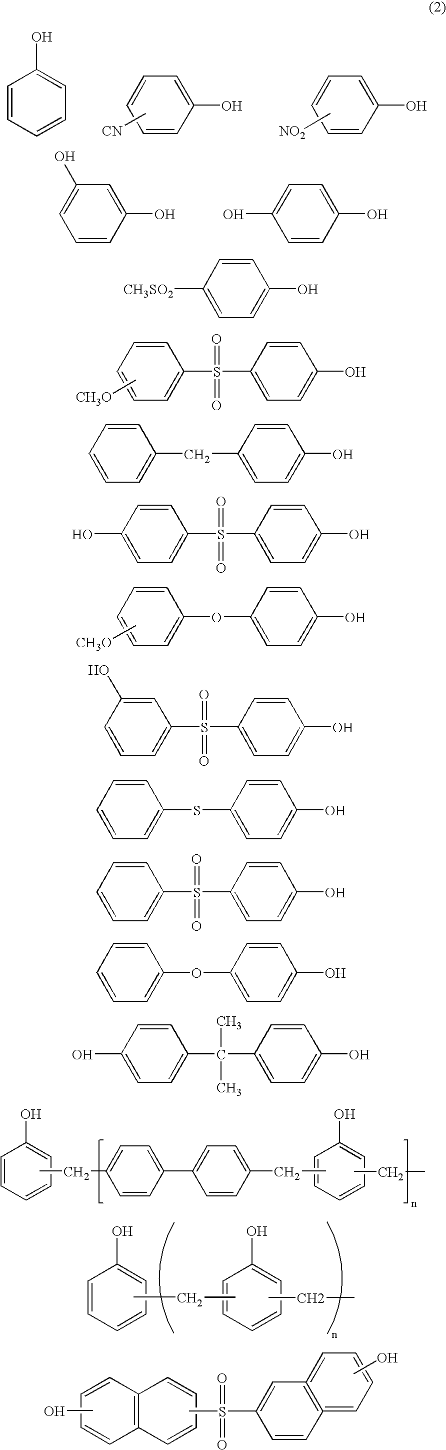

These phenol compounds may be used either singly or in combinations of plural types.

When a phenol compound as mentioned above is compounded as the first latent catalyst of the present invention, the amount of the phenol compound to be compounded is preferably about 0.1 to 50% by weight based on the resin. When the amount is less than 1% by weight, it is difficult to advance a curing reaction sufficiently. On the other hand, when the amount exceeds 50% by weight, workability and the hygroscopic property and mechanical strength of a cured product tend to be deteriorated.

Also, the organic metal compound which is a second latent catalyst in the present invention works as a curing catalyst and, for example, metal salt or a metal complex represented by the following formula is used.

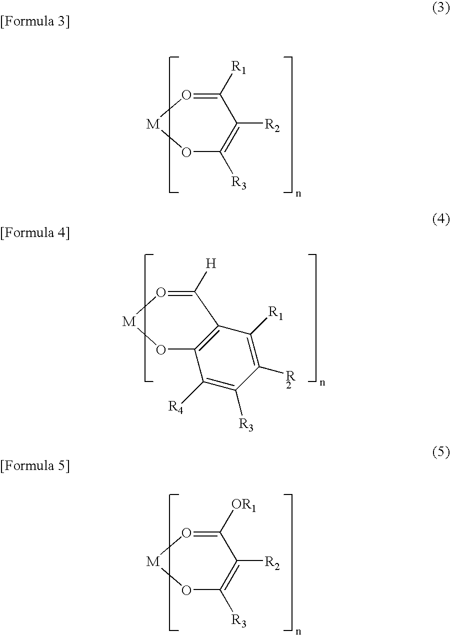

wherein M represents an element selected from the group consisting of Zr, Al, Ti, Cr, Mn, Fe, Co, Ni, Cu and Zn, n denotes an integer from 2 to 4 and R₁, R₂, R₃ and R₄, which may be the same or different, respectively represent a hydrogen atom or a substituted or unsubstituted hydrocarbon group having 1 to 30 carbon atoms.

In the compounds represented by the chemical formulae (3) to (5), it is unnecessary that all the connecting groups of the metal atom (M) are bound with ligands, but the connecting groups of the metal atom (M) may be bound with an alkoxy group, phenoxy group, acyloxy group, β-diketonato group, o-carbonylphenolate group or the like. Also, organic metal compounds as those mentioned above may be used singly or in combinations of two or more.

In the epoxy resin type composition of the present invention, the amount of the organic metal complex to be compounded is preferably 0.01 to 20% by weight and more preferably 0.1 to 10% by weight based on the epoxy resin. This reason is that if the amount of the organic metal compound is less than 0.01% by weight, the efficiency of polymerization when the epoxy resin is cured tends to be insufficient whereas if the amount exceeds 20% by weight, there is a fear that this causes a reduction in the reliability of the adhesiveness, heat resistance and moisture resistance of a cured product and also cost-up.

Here, examples of the alkoxy group include a methoxy group, ethoxy group, n-propoxy group, n-butoxy group, sec-butoxy group, tert-butoxy group, n-pentyloxy group, n-hexyloxy group and n-heptyloxy group each having 1 to 10 carbon atoms. Examples of the phenoxy group include a phenoxy group, o-methylphenoxy group, o-methoxyphenoxy group, p-nitrophenoxy group and 2,6-dimethylphenoxy group. Examples of the acyloxy group include ligands such as an acetate, propionate, isopropionate, butyrate, stearate, ethylacetoacetate, propylacetoacetate, butylacetoacetate, diethylmalorate, and dipivaloylmethanate. Examples of the β-diketonate group include ligands such as acetylacetonate, trifluoroacetylacetonate and hexafluoroacetylacetonate. Example of the o-carbonylphenolate includes salicylaldehydate.

Using an organic metal compound in which along chain having 10 or more carbon atoms is introduced into at least one of R₁, R₂, R₃ and R₄ in the ligands of the structural chain, the condition that the organic metal compound is isolated from a resin component can be utilized by allowing the organic metal compound to take the form of a colloid, micelle or crystal in the resin composition obtained by blending a phenol compound and the organic metal compound in an epoxy resin, for the purpose of improving the storage stability of a material. Specifically, it is possible to prevent an increase in viscosity and hardening with time and to make operable time longer than that of a conventional epoxy resin composition by using a material that is by nature dissolved and precipitated reversibly by heating and cooling. It is only necessary that the organic metal compound is confirmed to have an average particle diameter of preferably 0.1 μm or more though it has any size insofar as the latency of the catalytic action of the organic metal compound can be confirmed by, for example, a test for storage stability. For example, the organic metal compound precipitated in a resin composition in which the epoxy resin is mixed with the organic metal compound is collected and placed together with the resin on a glass plate and observed under heating by a microscope. In this case, it is only necessary that the clouded organic metal compound be dissolved into a transparent state. Moreover, it is more preferable that the endthermic peek of the organic metal compound in the resin composition which peek is derived from the dissolution of the compound be confirmed by DSC (differential scanning calorimetry) or the like.

As the organic group represented by the above chemical formulae (3) to (5) and introduced to impart the ability to dissolve and precipitate reversibly by heating and cooling, metal compounds containing, for example, an octadecyl acetoacetate group, hexadecyl acetoacetate group, tetradecyl acetoacetate group, dodecyl acetoacetate group, octylsalicylaldehyde group or octadecyl acetoacetate group have high storage stability and good heat-curability and are therefore particularly desirable.

As specific examples of the organic metal compound, organic zirconium compounds and organic aluminum compounds are most preferable. Specifically, as the organic zirconium compound, tetramethoxyzirconium, tetraethoxyzirconium, tetraisopropoxyzirconium, tetraphenoxyzirconium, tetraparamethylphenoxyzirconium, isopropoxytetraethoxyzirconium, tetrabutoxyzirconium, tetraacetoxyzirconium, zirconium tetrastearate, zirconium tetrabutyrate, zirconium tetrapropionate, zirconium tetraisopropionate, zirconiumtetraacetylacetonate, zirconium tetratrifluoroacetylacetonate, zirconium tetrahexafluoroacetylacetonate, zirconium tetraethylacetoacetonate, zirconium tetrasalicyl aldehydate, zirconium tetradiethylmalorate, zirconium tetrapropylacetoacetate, zirconium tetrabutylacetoacetate, zirconium tetradipivaloylmethanate or zirconium trisacetylacetonatedipivaloylmethanate may be used.

As the organic aluminum compound, trismethoxyaluminum, trisethoxyaluminum, trisisopropoxyaluminum, trisphenoxyaluminum, trisparamethylphenoxyaluminum, isopropoxydiethoxyaluminum, trisbutoxyaluminum, trisacetoxyaluminum, aluminum trisstearate, aluminum trisbutyrate, aluminum trispropionate, aluminum trisisopropionate, aluminum trisacetylacetonate, aluminum tristrifluorofluoroacetylacetonate, aluminum trishexafluoroacetylacetonate, aluminum trisethylacetoacetate, aluminum trissalicylaldehydate, aluminum trisdiethylmalorate, aluminum trispropylacetoacetate, aluminum trisbutylacetoacetate, aluminum trisdipivaloylmethanate or aluminum diacetylacetonatedipivaloylmethanate may be used.

In the invention, it is preferable to premix the phenol compound and the organic metal compound in advance in the epoxy resin in view of a uniform reaction of an epoxy resin type. As to the mixing method, these ingredients may be mixed at ambient temperature or under heating by using an apparatus generally called a mixer. When these components are used without mixing the latent catalyst, the reaction proceeds locally and it is therefore difficult to draw out the characteristics of materials.

(Butyral Resin)

As the butyral resin to be used in the present invention, any polymer may be used insofar as it is a polymer obtained from a polyvinyl alcohol by adding butylaldehyde in the presence of an acid catalyst. Further, a copolymer type which is copolymerisable with vinyl acetate or vinyl alcohol may also be used.

Specific examples of the butyral resin include SREC BL-1, BL-1H, BL-2, BL-5, BL-10, BL-S, BL-SH, BX-10, BX-L, BM-1, BM-2, BM-5, BM-S, BM-SH, BH-3, BH-6, BH-S, BX-1, BX-3, BX-5, KS-10, KS-1, KS-3 and KS-5 (the above products are manufactured by Sekisui Chemical Co., Ltd.). An appropriate resin may be optionally selected from the above resins from the viewpoint of compatibility with the epoxy resin and the viscosity of a resin.

The butyral resin used in the present invention is a rubber component that drops the elastic modulus of the epoxy resin and a component added to suppress the occurrence of cracks during a cooling-heating cycle test. As to the amount of the butyral resin to be added, the butyral resin may be added in an amount range from 0.1% to 50% by weight and preferably 1 to 20% by weight. When the amount is small, there is no effect of decreasing the elastic modulus whereas the amount exceeds 50% by weight, the viscosity of the epoxy resin type increases, leading to reduced workability. Further, the butyral resin may be dissolved and mixed in the epoxy resin in advance in consideration of dispersion in the epoxy resin.

(Inorganic Filler)

As the inorganic filler to be used in the present invention, fused silica, crystalline silica, glass, talc, alumina, calcium silicate, calcium carbonate, barium sulfate, magnesia, silicon nitride, boron nitride, aluminum nitride, magnesium oxide, beryllium oxide and mica may be used. Among these materials, fused silica and crystalline silica are particularly preferable. As to the shape of the inorganic filler, fillers having a crushed form, globular form, semi-globular form, fibrous form or scaly form may be used. A globular or semi-globular filler having an average particle diameter of 10 μm or less is particularly preferable in consideration of the filling characteristics in interstices of fine parts of a liquid resin. A fibrous one may be used with aiming at the effect of reinforcing crutch resistance. Examples of the fibrous filler include whiskers such as titania, aluminum borate, silicon carbide, silicon nitride, potassium titanate, basic magnesium, zinc oxide, graphite, magnesia, calcium sulfate, magnesium borate, titanium diborate, α-alumina, chrysotile and wollastonite, amorphous fibers such as E glass fiber, silica alumina fiber and silica glass fiber and crystalline fibers such as chirano fiber, silicon carbide fiber, zirconia fiber, γ-alumina fiber, α-alumina fiber, PAN type carbon fiber and pitch type carbon fiber.

As the above fibrous filler, those having an average fiber diameter of 5 μm or less and a maximum fiber length of 10 μm are preferable from the viewpoint of filling characteristics in fine parts.

The inorganic filler used in the present invention may be used in an amount of 10% by weight or more based on the total amount of the epoxy resin composition for coating. When the amount of the inorganic filler is small, the thermal expansion coefficient of a cured product increases, resulting in unsatisfactory resistance to heat impact. Also, when the amount exceeds 80% by weight, the fluidity of the resin composition is insufficient, so that filling characteristics in interstices are decreased, causing the resin composition to be unfilled and an amount out of the above range is therefore undesirable.

(Other Additives)

A thermoplastic resin, rubber component and various oligomers may be added with the intention of dropping the elastic modulus of the composition for improvement of crack resistant. Specific examples of the thermoplastic resin include a polyamide resin, aromatic polyester resin, phenoxy resin, MBS resin and ABS resin: these resins may be modified by silicone oil, silicone resin, silicone rubber, or fluorine rubber. Also, it is possible to impart low-stress characteristics by adding various plastic powders and various engineering plastic powders. A maximum particle size of the component imparting low stress characteristics is 10 μm or less and preferably 5 μm or less. When the particle size of the modifier contained in the epoxy resin coating material of various modifying agents in the liquid epoxy resin composition of the present invention is large, the coated surface is deteriorated and filling characteristics in fine parts are inferior, causing the occurrence of voids. Other than the above, an adhesion-imparting agent for improving adhesiveness to print boards, packaged semiconductor packages and metal terminals, surfactants, coupling agents, colorants and the like may be compounded according to the need. A reactive type low-molecular epoxy resin, a solvent and the like may be further added as a viscosity regulator. The liquid epoxy resin composition of the present invention is uniformly mixed with the filler component and the resin component by using a three-roll mill, ballmill, crusher, homogenizer, rotation-revolution type mixer, universal mixer, extruder, Henshel mixer or the like and then the mixture is filled in a dispenser or the like when used.

(Electronic Devices)

Electronic devices to which the present invention is preferably applied are those in which a nonaqueous solvent battery, such as a lithium ion battery, which is secured to and disposed on a printed wiring board is isolated from an electronic circuit disposed at a position adjacent to the battery by the epoxy resin composition.

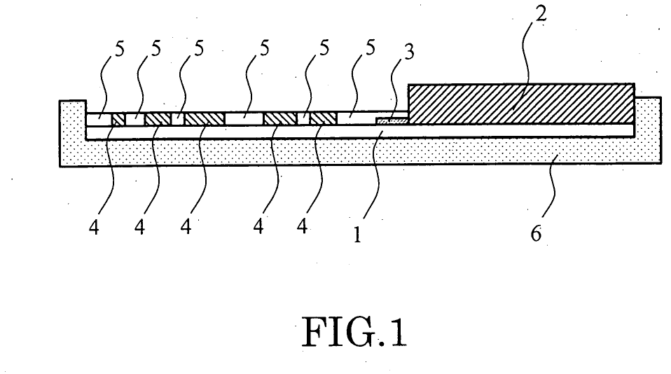

FIG. 1 shows one example of an electronic device in this embodiment. FIG. 1 is a view of an example of an electronic device in which a nonaqueous solvent battery and an electronic circuit are mounted on the same wiring substrate. A nonaqueous solvent battery 2 is mounted on a wiring substrate 1 and wirings 3 made of copper are formed adjacent to the battery 2. Also, other electronic part 4 is disposed adjacent to the nonaqueous solvent battery 2. An electronic circuit is formed by these wirings 3 and the electronic part 4. These substrate 1, battery 2, wiring 3, electronic parts 4 are set in a casing 6. A region 5 which is a part adjacent to the nonaqueous solvent battery 2 in this electronic circuit is coated with an epoxy resin composition. This figure shows an example in which an epoxy resin composition is applied. However, the composition may be molded into a thick-film.

In the present invention, the electronic circuit adjacent to the nonaqueous solvent battery which circuit must be protected with the epoxy resin composition means that an electronic circuit which a nonaqueous electrolyte probably reaches when the nonaqueous electrolyte leaks from the nonaqueous solvent battery for some reason is preferably protected with the epoxy resin composition. Although the range of the electronic circuit to be protected differs depending on the circuit design of the electronic device or the form in using the electronic device, a part of the electronic circuit disposed within 30 cm from the nonaqueous solvent battery is preferably protected.

The isolation of the electronic circuit by the epoxy resin composition in this electronic device may be accomplished either by coating the surface of the electronic circuit with the epoxy resin composition or by coating the nonaqueous solvent battery with the epoxy resin composition. Also, a container with an opening part may be made of the epoxy resin composition and disposed on the battery or the electronic circuit to isolate the both from each other.

When the epoxy resin composition is used to coat, the film thickness of the resin composition is preferably in a range from 2 to 1000 μm. When this film thickness is less than the above range, insufficient solvent resistance is obtained and therefore only insufficient isolating effect is produced. On the other hand, when the film thickness exceeds the above range, an improvement in the effect according to an increase in the film thickness is not observed, which is uneconomical.

Examples of the aforementioned electronic circuit include control circuits and protective circuits for the above nonaqueous solvent battery or other electronic circuits: however, the present invention is not limited to these circuits at all.

Further, the liquid epoxy resin composition of the present invention may be used not only as a coating material for the above protective substrate but also in the fields of precision electronic parts, precision electric parts, motor parts, aerospace materials, sliding materials, heat resistant laminate plates, mounting agents and casting materials and at places where chemical resistance is particularly required as heat resistant adhesives and paints.

(Action)

The liquid epoxy resin composition of the present invention contains (a) an epoxy resin, (b) a phenol compound and an organic metal compound as a latent catalyst, (c) a butyral resin and (d) an inorganic filler and is a liquid epoxy resin composition superior in resistance to cooling-heating cycle cracks, adhesion and coating characteristics to conventional epoxy resin coating agent compositions. The liquid epoxy resin composition of the present invention is a one-liquid type and free from a problem concerning storage stability and is an electronic circuit protective resin composition improved in conventional problems concerning reliability in long-term moisture resistance and cooling-heating crack characteristics. The liquid epoxy resin composition of the present invention enables a highly reliable electronic device to be realized by isolating a nonaqueous solvent battery from an electronic circuit adjacent to the battery.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### EXAMPLES

The present invention will be explained in more detail by way of examples, in which all designations of compounding ratio are on the basis of “%” by weight.

### (Examples 1 to 8) and (Comparative Examples 1 to 3)

Filler components and resin components were respectively compounded according to the compositions in the following Table 1 and the ingredients were mixed for 10 minutes at a rotation of 30 rpm at ambient temperature by using a three-roll mill. Then, blended ingredients were placed in a dispenser and a part of a test substrate packaged with parts was coated with the epoxy resin. The substrate had a size of 60 mm×25 mm with a thickness of 0.2 mm. Next, the substrate was heat-treated in the condition of 60° C.×1 Hr and then 130° C.×1 Hr to carry out a test for electrolyte resistance. Also, an electrolyte was dripped between counter electrodes of the test substrate and a DC voltage of 18 V and a current of 3.0 A were applied to make a check for leak current. A cooling-hating cycle test in a temperature range from −65° C. to 120° C. was carried out as a crack resistance test to investigate the rate of the occurrence of cracks in each cycle.

TABLE 1

| | | | | | | | | | | | Compara- |
|---|---|---|---|---|---|---|---|---|---|---|---|
| | | | | | | | | | Comparative | Comparative | tive |
| | Example 1 | Example 2 | Example 3 | Example 4 | Example 5 | Example 6 | Example 7 | Example 8 | Example 1 | Example 2 | Example 3 |
| Epoxy | 30 | — | — | 30 | 30 | 30 | 30 | — | 32 | 15.8 | 18.9 |
| resin A | | | | | | | | | | | |
| Epoxy | — | 30 | — | — | — | — | — | — | — | — | — |
| resin B | | | | | | | | | | | |
| Epoxy | — | — | 30 | — | — | — | — | 34 | — | — | — |
| resin C | | | | | | | | | | | |
| Epoxy | 4 | 4 | 4 | 4 | 4 | 4 | 4 | — | 4 | 4 | 4 |
| resin D | | | | | | | | | | | |
| Hardener A | — | — | — | — | — | — | — | — | — | 15.8 | — |
| Hardener B | — | — | — | — | — | — | — | — | — | — | 12.6 |
| Metal | 1.75 | 1.75 | 1.75 | — | — | 1.75 | 1.75 | 1.75 | 1.75 | — | — |
| complex A | | | | | | | | | | | |
| Metal | — | — | — | 1.75 | — | — | — | — | — | — | — |
| complex B | | | | | | | | | | | |
| Metal | — | — | — | — | 1.75 | — | — | — | — | — | — |
| complex C | | | | | | | | | | | |
| Micro- | — | — | — | — | — | — | — | — | — | 1.9 | 2 |
| capsule | | | | | | | | | | | |
| type | | | | | | | | | | | |
| curing | | | | | | | | | | | |
| catalyst | | | | | | | | | | | |
| Phenol | 1.75 | 1.75 | 1.75 | 1.75 | 1.75 | | 1.75 | 1.75 | 1.75 | — | — |
| compound A | | | | | | | | | | | |
| Phenol | — | — | — | — | — | 1.75 | — | — | — | — | — |
| compound B | | | | | | | | | | | |
| Butyral | 2 | 2 | 2 | 2 | 2 | 2 | | 2 | | 2 | 2 |
| resin A | | | | | | | | | | | |
| Butyral | — | — | — | — | — | — | 2 | — | — | — | — |
| resin B | | | | | | | | | | | |
| Filler | 60 | 60 | 60 | 60 | 60 | 60 | 60 | 60 | 60 | 60 | 50 |
| Coupling | 0.2 | 0.3 | 0.3 | 0.3 | 0.3 | 0.3 | 0.3 | 0.3 | 0.2 | 0.3 | 0.3 |
| agent | | | | | | | | | | | |
| Colorant | 0.2 | 0.2 | 0.2 | 0.2 | 0.2 | 0.2 | 0.2 | 0.2 | 0.2 | 0.2 | 0.2 |
| Surfactant | 0.1 | 0.1 | 0.1 | 0.1 | 0.1 | 0.1 | 0.1 | 0.1 | 0.1 | 0.1 | 0.1 |

Each component constituting the resin compositions described in Table 1 designates the following material.

Epoxy resin A: Bisphenol F type epoxy resin (Epikote 807 manufactured by Japan Epoxy Resins Co., Ltd.)

Epoxy resin B: Bisphenol A type epoxy resin (Epikote 828 manufactured by Japan Epoxy Resins Co., Ltd.)

Epoxy resin C: Alicyclic epoxy resin (Celokiside 2021P manufactured by Daicel Chemical Industries, Ltd.)

Epoxy resin D: 1,6-cyclohexanediol diglycidyl ether (EPICRON726D manufactured by Dainippon Ink and Chemicals, Incorporated)

Hardener A: 4-Methylhexahydrophthalic acid anhydride (Rikasid MH-700, manufactured by New Japan Chemical Co., Ltd.)

Hardener B: Heterocyclic diamine (Epomate B002 manufactured by Japan Epoxy Resins Co., Ltd.)

Metal complex A: Zirconium tetraacetylacetonate (manufactured by Matsumoto Chemical Industry Co., Ltd.)

Metal complex B: Aluminum triacetylacetonate (manufactured by Kawaken Fine Chemical Co., Ltd.)

Netal complex C: Zirconium tetra (octadecylacetoacetate)

Microcapsule type curing catalyst: (Novacure HX-3088 manufactured by Asahi Chemical Industry Co., Ltd.)

Phenol compound A: 4,4′-dihydroxydiphenylsulfone (BPS-P manufactured by Nicca Chemical Co., Ltd.)

Phenol compound B: Catechol-O-dihydroxybenzene

Butyral resin A: (ESREC BL-S manufactured by Sekisui Chemical Co., Ltd.)

Butyral resin B: (ESREC BL-1 manufactured by Sekisui Chemical Co., Ltd.)

Filler: Synthetic silica (Adomafine SOE5 manufactured by Adomatex Co., Ltd.)

Coupling agent: (A-187 manufactured by Nippon Unicar Co., Ltd.)

Colorant: Carbon black (MA-600 manufactured by Mitsubishi Chemical Co., Ltd.)

Surfactant: Fluorine type surfactant (FC-430 manufactured by Sumitomo 3M Ltd.)

Test Using a Test Substrate

Using the test substrate shown in FIG. 1, the electrode part was coated with a resin to inspect short-circuit current developing time. Also, with regard to the test substrate, a cooling-heating cycle test was made to check on whether cracks occurred or not.

The test method is as follows.

Outward appearance of the applied resin: The surface of the coated resin was observed by a microscope to find the occurrence of voids, presence or absence of peeled places and uniformity of a coating film.

Presence of cracks: The presence of outside cracks in the applied resin was observed by a microscope after the cooling-heating cycle test.

Adhesiveness (red inktest): A coating substrate was placed in a pressure cocker filled with red ink to treat the substrate in an atmosphere under 2.5 atm for 2 hours. The substrate was washed with water and water was wiped to observe whether or not the ink enters a boundary between the coating material and the substrate by a microscope.

Test for resistance to an electrolyte: The substrate was dipped in a 50° C. electrolyte for 2 hours, the electrolyte was removed by washing and then, the condition of the substrate was observed.

Short-circuit developing time: The electrode part of the circuit board was coated with a resin and after-cured. A voltage of 18 V was applied to investigate the presence of leak current due to ion migration and the time passed till short-circuit was developed.

Further, the following general characteristics were measured using trial liquid epoxy resin compositions.

Gel time: Curing speed on a 130° C. heat plate was measured.

Storage stability: As a test for the storage stability of a coating material, the material was stored in a 25° C. atmosphere to investigate a change in viscosity.

Viscosity (25° C.): The viscosity at 25° C. was measured using a E-type viscometer manufactured by Toki Sangyo Co., Ltd.

Glass transition point: The glass transition point was measured using TMA manufactured by Seiko Denshi.

Thermal expansion coefficient: The thermal expansion coefficient was measured using TMA manufactured by Seiko Denshi.

Bending strength and elastic modulus: Measured according to JIS K-6911.

Water absorption (85° C., 85%, 168 Hrs): The coefficient of water absorption was measured using a high temperature humidistat manufactured by TABAI.

The results of the above tests are shown in Table 2.

TABLE 2

| | | | | | | | | | | Compara- | Compara- | Compara- |
|---|---|---|---|---|---|---|---|---|---|---|---|---|
| | | | | | | | | | | tive | tive | tive |
| | | Example 1 | Example 2 | Example 3 | Example 4 | Example 5 | Example 6 | Example 7 | Example 8 | Example 1 | Example 2 | Example 3 |
| Gel time | | 180 | 210 | 32 | 290 | 540 | 120 | 100 | 26 | 165 | 190 | 140 |
| (130° C., sec) | | | | | | | | | | | | |
| Viscosity | | 3860 | 6430 | 2563 | 3480 | 3350 | 4320 | 3987 | 7765 | 2466 | 2967 | 5758 |
| (25° C., mPa · s) | | | | | | | | | | | | |
| Glass transition | | 125 | 122 | 128 | 155 | 98 | 128 | 123 | 134 | 126 | 131 | 92 |
| point (° C.) | | | | | | | | | | | | |
| Thermal | | 35.4 | 34.7 | 39.4 | 36.6 | 41.5 | 32.3 | 32.6 | 32.0 | 35.8 | 36 | 34.2 |
| expansion | | | | | | | | | | | | |
| coefficient α1 | | | | | | | | | | | | |
| (×10⁻⁵1/° C.) | | | | | | | | | | | | |
| Bending strength | | 14.7 | 16.8 | 17.8 | 13.6 | 12.8 | 14.9 | 15.1 | 16.8 | 15.1 | 16.1 | 16.5 |
| [25° C.] (Mpa) | | | | | | | | | | | | |
| Bending elastic | | 1150 | 1230 | 1290 | 1203 | 1106 | 1287 | 1260 | 1250 | 1480 | 1210 | 1210 |
| modulus | | | | | | | | | | | | |
| [25° C.] (Gpa) | | | | | | | | | | | | |
| Coefficient of | | 3600 | 4500 | 5400 | 3500 | 3250 | 3820 | 3100 | 2890 | 3300 | 6400 | 4200 |
| water absorption | | | | | | | | | | | | |
| [85° C., 85%, | | | | | | | | | | | | |
| 168 H] (ppm) | | | | | | | | | | | | |
| Storage stability | | 69 | 32 | 16 | 73 | 186 | 64 | 73 | 25 | 150 | 120 | 0.04 |
| (25° C.) | | | | | | | | | | | | |
| Days required for | | | | | | | | | | | | |
| the viscosity to be | | | | | | | | | | | | |
| increased twice | | | | | | | | | | | | |
| the original | | | | | | | | | | | | |
| viscosity (days) | | | | | | | | | | | | |
| Outward | | ◯ | ◯ | ◯ | ◯ | ◯ | ◯ | ◯ | ◯ | ◯ | ◯ | ◯ |
| appearance of a | | | | | | | | | | | | |
| coating resin | | | | | | | | | | | | |
| Adhesiveness | | ◯ | ◯ | ◯ | ◯ | ◯ | ◯ | ◯ | ◯ | ◯ | X | Δ |
| (red ink test) | | | | | | | | | | | | |
| Short-circuit | | No | No | No | No | No | No | No | No | 4 | 1 | 12 |
| developing | | occurrence | occurrence | occurrence | occurrence | occurrence | occurrence | occurrence | occurrence | | | |
| time (days) | | | | | | | | | | | | |
| Cooling- | 199 | 0/20 | 0/20 | 0/20 | 0/20 | 0/20 | 0/20 | 0/20 | 0/20 | 0/20 | 17/20 | 8/20 |
| heating | cycle | | | | | | | | | | | |
| cycle test | 200 | 0/20 | 0/20 | 0/20 | 0/20 | 0/20 | 0/20 | 0/20 | 0/20 | 0/20 | 20/20 | 19/20 |
| (−65˜ | cycle | | | | | | | | | | | |
| 120° C.) | 500 | 0/20 | 0/20 | 0/20 | 0/20 | 0/20 | 0/20 | 0/20 | 0/20 | 0/20 | — | 20/20 |
| (cycle) | cycle | | | | | | | | | | | |
| Number of | | | | | | | | | | | | |
| Generated | | | | | | | | | | | | |
| cracks/ | | | | | | | | | | | | |
| Number of | | | | | | | | | | | | |
| samples | | | | | | | | | | | | |

| | | | | | | | | | | | |
|---|---|---|---|---|---|---|---|---|---|---|---|
| Test for resis- | ◯ | ◯ | ◯ | ◯ | ◯ | ◯ | ◯ | ◯ | ◯ | X Coating | Δ Coating |
| tance to an | | | | | | | | | | film was | film was |
| electrolyte | | | | | | | | | | deterior- | deterior- |
| 50° C., | | | | | | | | | | ated | ated |
| processing time: | | | | | | | | | | (peeled | |
| 2 Hrs | | | | | | | | | | off) | |

As a result of the above examples and comparative examples, it is found that the liquid epoxy resin composition of the present invention has higher coatability than each epoxy resin coating composition of Comparative Examples 1 and 3, is free from the occurrence of voids and peeling and is superior in filling characteristics in fine parts. Also, as to general characteristics, the resin composition has high storage stability, high glass transition point with low viscosity, low thermal expansion coefficient and superb mechanical characteristics and is a heat resistant resin. Also, it is found that a substrate using the composition as a coating material has high reliability in moisture resistance and is also superior in crack resistance in a cooling-heating cycle test. Therefore, if a lithium battery protective substrate is coated with the liquid epoxy resin composition of the present invention, a battery device having good reliability over a long term can be manufactured.

According to the present invention, an epoxy resin composition that is suitable for use as a surface coating of a battery protective circuit and is free from the fear of the development of short-circuits can be attained. Also, in electronic devices using this epoxy resin composition for coating, devices having high durability can be realized.

What is claimed is:

1. An electronic device comprising a nonaqueous solvent battery disposed on a substrate and an electronic circuit disposed adjacent to the battery, wherein the electronic circuit is isolated from the battery by an epoxy resin composition containing:
(a) an epoxy resin;
(b) a latent catalyst consisting of a phenol compound and an organic metal compound;
(c) a butyral resin; and
(d) an inorganic filler.

2. An electronic device according to claim 1, the average particle diameter of said inorganic filler is 10 μm or less and the ratio of the inorganic filler in said epoxy resin composition is 10% by weight or more and 80% by weight or less.

3. An electronic device according to claim 1, wherein said organic metal compound is a metal complex.

4. An electronic device according to claim 1, wherein said phenol compound is a bisphenol S and said organic metal compound is made of a zirconium type compound.

5. An electronic device according to claim 1, wherein said epoxy resin is an epoxy resin homopolymer.

6. An electronic device according to claim 2, wherein said organic metal compound is a metal complex.

7. An electronic device according to claim 2, wherein said phenol compound is a bisphenol S and said metal complex is made of a zirconium type compound.

8. An electronic device according to claim 2, wherein said epoxy resin is an epoxy resin homopolymer.

9. An electronic device according to claim 1, wherein said epoxy resin composition covers said electronic circuit.

10. An electronic device according to claim 1, wherein said epoxy resin composition covers said nonaqueous solvent battery.

11. An electronic device according to claim 1, wherein said epoxy resin composition is molded into the form of a container and the container encloses said nonaqueous solvent battery.

12. An electronic device according to claim 1, wherein said epoxy resin composition is molded into the form of a container and the container encloses said electronic circuit.

13. An electronic device according to claim 1, wherein said electronic circuit is a control circuit for said nonaqueous solvent secondary battery.

14. An electronic device according to claim 1, wherein said electronic circuit is a protective circuit for said nonaqueous solvent secondary battery.

15. An electronic device comprising a battery using a nonaqueous electrolyte and a battery protective circuit arranged adjacent to the battery, the battery protective circuit being coated with an epoxy resin composition containing an epoxy resin, a latent catalyst consisting of a phenol compound and an organic metal compound, a butyral resin and an inorganic filler.

16. An electronic device according to claim 15, the average particle diameter of said inorganic filler is 10 μm or less and the ratio of the inorganic filler in said epoxy resin composition is 10% by weight or more and 80% by weight or less.

17. An electronic device according to claim 15, wherein said organic metal compound is a metal complex.

18. An electronic device according to claim 15, wherein said phenol compound is a bisphenol S and said organic metal compound is made of a zirconium type compound.

19. An electronic device according to claim 1, wherein said epoxy resin is an epoxy resin homopolymer.
